(19) United States
(12) Patent Application Publication
(10) Pub. No.: US 2014/0075471 A1
(43) Pub. Date: Mar. 13, 2014

(54) APPARATUS, SYSTEMS AND METHODS FOR ACCESSING SUPPLEMENTAL INFORMATION PERTAINING TO A NEWS SEGMENT

(71) Applicant: Artem Antonets, Kharkiv (UA)

(72) Inventor: Artem Antonets, Kharkiv (UA)

(73) Assignee: EchoStar Ukraine LLC, Kharkiv (UA)

(21) Appl. No.: 14/116,538

(22) PCT Filed: May 11, 2011
(86) PCT No.: PCT/UA11/00035

§ 371 Date: Nov. 8, 2013

(51) Int. Cl. H04N 21/81; H04N 21/488; H04N 21/4722

(52) U.S. Cl. CPC H04N 21/8126; H04N 21/4722; H04N 21/488
USPC 725/32

(57) ABSTRACT

Systems and methods are operable to access additional supplemental information pertaining to a supplemental information window presented during a news broadcast event. An exemplary embodiment serially presents a plurality of news segments of the news broadcast event on a display, presents at least one supplemental information window concurrently with the presented plurality of news segments on the display, receives a request to present additional supplemental information that is associated with the at least one supplemental information window, accesses the additional supplemental information, and presents the additional supplemental information on the display.

### BACKGROUND

Media devices, such as a set top box, television, computer system, smart phone, portable media device, or the like, are often configured to receive media content events corresponding to a news broadcast event. The news broadcast event is typically a series of sequentially presented short news segments describing newsworthy stories. The duration of a news segment may vary based upon the degree of newsworthiness of the story. Further, the subject matter of each news segment will vary from one news segment to the next news segment. For example, a natural disaster having a worldwide impact may be presented using a relatively long news segment and/or a series of related news segments. In contrast, a news segment describing local weather or a local event may be presented using a single, relatively short news segment.

Because of the limited duration of a news broadcast event, only a limited number of news segments presenting stories pertaining to the most important, most interesting, or more relevant newsworthy events may be presented during a single news broadcast event. To facilitate presentation of other newsworthy information, such as stories of less newsworthy events, or repetition of information for an extraordinary newsworthy story, supplemental textual information may be presented concurrently with the presented news segments.

The amount of supplemental textual information and/or the level of detail presented in the supplemental textual information is typically limited in scope. However, at times, the user viewing the supplemental textual information may be particularly interested in the subject matter of the news event described in the supplemental textual information. In such situations, the user may access an alternative news source to access additional and/or more detailed information about the news event described in the window. For example, the user may switch to a different channel to access the additional and/or more detailed information. Alternatively, or additionally, the user may access the internet to obtain the additional and/or more detailed information from a web site or the like.

There may be a considerable inconvenience to the user when accessing alternate sources of information pertaining to the news event described in the window. Accordingly, there is a need in the arts to provide a more convenient way for the user to access additional information pertaining to the news event described in the supplemental textual information.

### SUMMARY

Systems and methods of accessing additional supplemental information pertaining to a supplemental information window presented during a news broadcast event are disclosed. An exemplary embodiment serially presents a plurality of news segments of the news broadcast event on a display, presents at least one supplemental information window concurrently with the presented plurality of news segments on the display, receives a request to present additional supplemental information that is associated with the at least one supplemental information window, accesses the additional supplemental information, and presents the additional supplemental information on the display.

### BRIEF DESCRIPTION OF THE DRAWINGS

Preferred and alternative embodiments are described in detail below with reference to the following drawings:

FIG. 1 is a block of an embodiment of a news segment enhancement system implemented in a media device;

FIG. 2 conceptually illustrates presentation of the additional supplemental information pertaining to a supplemental information window by an exemplary embodiment; and

FIG. 3 is a block diagram of an embodiment of a news segment enhancement system implemented in a media device that is a set top box.

### DETAILED DESCRIPTION

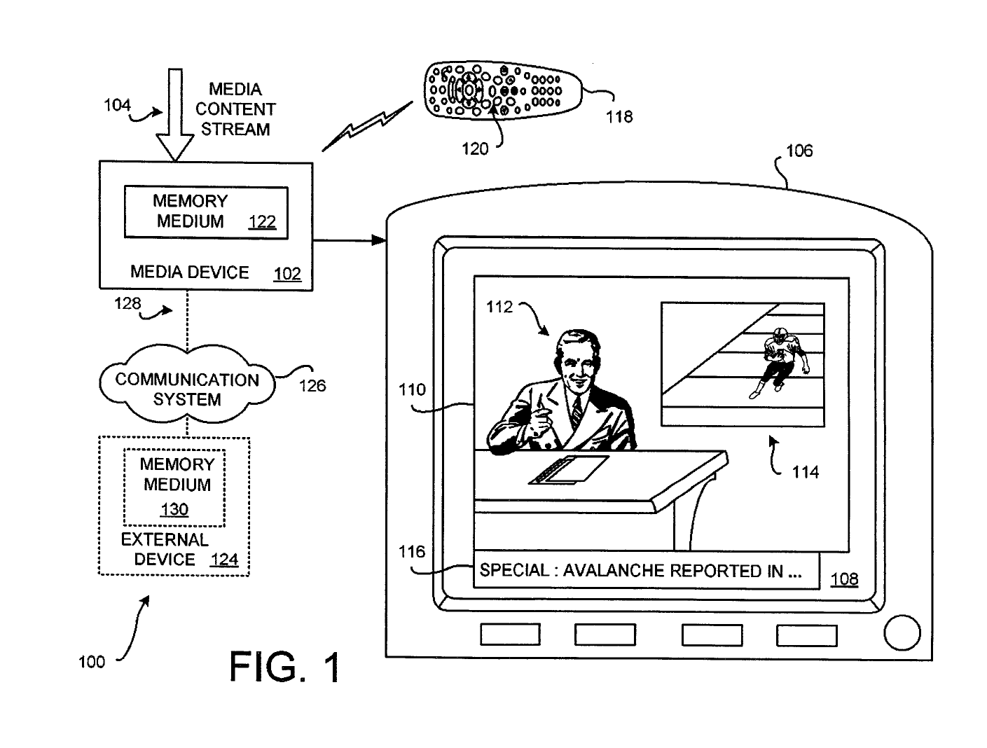

FIG. 1 is a block diagram of an embodiment of a news segment enhancement system 100 implemented in a media device 102, such as, but not limited to, a set top box (STB). Embodiments of the news segment enhancement system 100 may be implemented in other media devices, such as, but not limited to, a television (TV), a digital video disc (DVD) player, a digital video recorder (DVR), a game playing device, an electronic note pad, an electronic tablet, a personal computer (PC) or the like that is configured to receive a media content stream 104. A media content event received in the media content stream 104 is presented on a media presentation device 106 having a video display 108 and one or more optional speakers (not shown). Exemplary media content events include serial programs, movies, sporting events, news broadcasts, and other media content. In some embodiments, the media device 102 and the media presentation device 106 are a single integrated electronic device.

When the media content event is a news broadcast or the like, a series of news segments are sequentially presented to the user. A video portion 110 of the news segment is presented on a display 108 of the media presentation device 106. An audio portion of the received media content event is reproduced as sounds by speakers (not shown) of the media presentation device 106 or by another electronic sound reproducing device.

FIG. 1 conceptually illustrates a news broadcast event wherein a broadcaster 112 is shown in the video portion 110. The broadcaster 112 is apparently describing a play of interest from a football game, wherein a video clip 114 of the related play is being shown to the right of the broadcaster 112. After the broadcaster 112 describes this particular newsworthy event, a different news segment describing a different newsworthy event will be presented.

Shown below the image of the broadcaster 112 is a supplemental information window 116. The supplemental information window 116 may be shown in other areas of the display 108, such as to the sides or above the supplemental information window 116. In some embodiments, multiple supplemental information windows 116 are presented. Preferably, the supplemental information window 116 is presented in a portion of the display 108 that does not interfere with, or substantially interfere with, presentation of the video portion 110 of the news segment.

The supplemental information window 116 is a relatively small region of the viewable area of the display 108 that is used to present supplemental textual and/or graphical information pertaining to a news event. The subject matter of the supplemental information presented in the supplemental information window 116 may be related to the currently presented news segment, or the supplemental information may be related to a different newsworthy event. FIG. 1 conceptually illustrates that the example supplemental information window 116 is presenting textual information pertaining to a reported avalanche. In an exemplary embodiment, the presented information in the window 116 is scrolled so that the text of the additional supplemental information may be understood by the user.

In some situations, the user may be interested in accessing additional supplemental information pertaining to the subject matter presented in the supplemental information window 116. Embodiments of the news segment enhancement system 100 are configured to permit the user to selectively access such additional supplemental information using the exemplary media device 102.

The additional supplemental information is information that further supplements the information presented in the supplemental information window 116. Generally, the additional supplemental information presents in greater detail the subject matter described in the supplemental information window 116. The separately presented additional supplemental information may include textual information, image information, video information, and/or audio information.

In an exemplary embodiment, if the additional supplemental information pertaining to the supplemental information window 116 is available, the user may operate a suitable user interface which initiates retrieval and presentation of the additional supplemental information. In response to the user's request, the additional supplemental information pertaining to the supplemental information window 116 is presented on the media presentation device 106.

For example, FIG. 1 illustrates one example type of user interface, a remote control 118 having a plurality of button-type controllers 120 thereon. The controllers 120 are actuated by the user to generate requests that control operation of the media device 102 and/or the media presentation device 106. In an exemplary embodiment, a predefined one of the controllers 120 is configured to invoke presentation of the additional supplemental information. In response to receiving the user request, the additional supplemental information is accessed and is presented.

In some embodiments, the additional supplemental information is provided in the media content stream 104 received by the media device 102. The additional supplemental information, in an exemplary embodiment, is provided as a separate stream of information in the media content stream 104. Much like changing channels, the media device 102 tunes to the dedicated media content stream 104 carrying the additional supplemental information, and then retrieves the additional supplemental information therefrom.

Alternatively, the additional supplemental information pertaining to the supplemental information window 116 may be interleaved with the content of the news broadcast event. In response to receiving a user selection, the additional supplemental information is extracted from the interleaved media content of the media content stream 104.

In some embodiments, the media device 102 is configured to access the additional supplemental information pertaining to the supplemental information window 116 from an external device 124 via a communication system 126. The media device 102 establishes a communication link 128 to the external device 124 and submits a request for the additional supplemental information. The additional supplemental information is retrieved from a memory medium 130 by the external device 124, and is communicated to the media device 102 for presentation to the user.

When the additional supplemental information pertaining to the supplemental information window 116 is presented to the user, some embodiments are configured to pause presentation of the news broadcast event. In some embodiments, the news broadcast event may be optionally saved into the memory medium 122. Once presentation of the additional supplemental information has concluded, presentation of the news broadcast event resumes from the paused point (or the saved point) of the news broadcast event. If the user is not interested in the resumed news segments, the user may employ one or more trick presentation functions to more rapidly advance through the presented portion of the news broadcast event.

Alternatively, or additionally, the newscast may not be paused. In such situations, when the additional supplemental information includes audio information, the audio portion of the news broadcast event may be muted. Once presentation of the additional supplemental information has concluded, presentation of the news broadcast event resumes based on the currently received media content stream 104. For example, the user may not be interested in sports, and accordingly, would prefer not to have the news broadcast event paused while the requested additional supplemental information is being presented.

The exemplary communication system 126 is illustrated as a generic communication system. In one embodiment, the communication system 126 comprises a cellular telephone system, such as a radio frequency (RF) wireless system. Accordingly, the media device 102 includes a suitable transceiver. Alternatively, the communication system 126 may be a telephony system, the Internet, a Wi-fi system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. Additionally, embodiments may be implemented to communicate using other types of communication technologies, such as but not limited to, digital subscriber loop (DSL), X.25, Internet Protocol (IP), Ethernet, Integrated Services Digital Network (ISDN) and asynchronous transfer mode (ATM). Also, media device 102 may be configured to communicate over combination systems having a plurality of segments which employ different formats for each segment that employ different technologies on each segment.

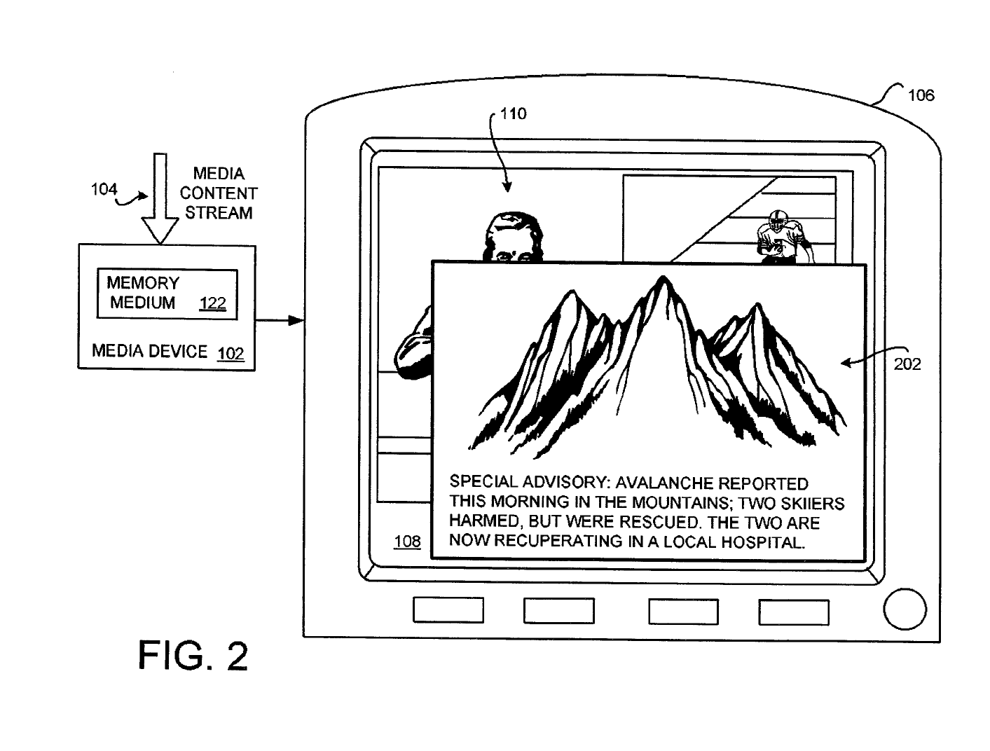

FIG. 2 conceptually illustrates an exemplary graphical presentation of the additional supplemental information pertaining to the supplemental information window 116 (FIG. 1). In response to selection by the user for presentation of the additional supplemental information, an additional supplemental information image 202 is presented on the display 108. In FIG. 1, the additional supplemental information image 202 is presented using a picture-in-picture (PIP) or picture-over-picture (POP) format. Other presentation formats may be used. In some embodiments, the additional supplemental information image 202 completely replaces the video portion 110 of the news segment.

The exemplary illustrated additional supplemental information image 202 presents textual information pertaining to the avalanche. Further, an image of the location of the avalanche is provided in the additional supplemental information image 202. If audio information is available, such as sounds recorded during the avalanche and/or commentary by a newscaster, the audio information is concurrently presented in synchronism with the presented additional supplemental information image 202. Video information may also be presented in the additional supplemental information image 202. In embodiments where presentation of the news segment continues, the audio portion of the news segment may be muted.

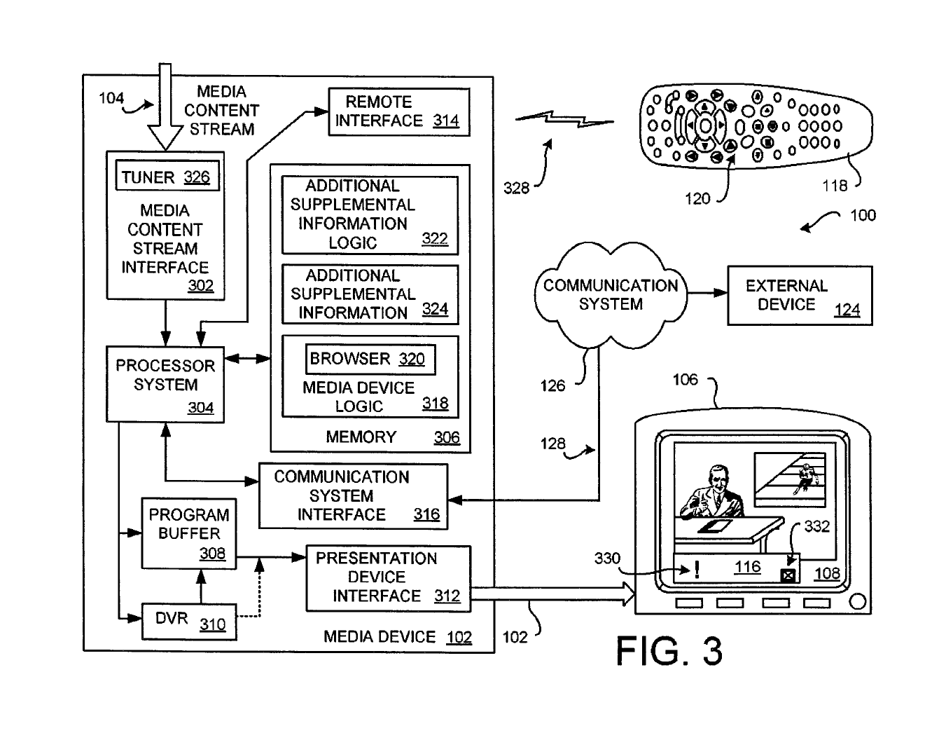

FIG. 3 is a block diagram of the news segment enhancement system 100 that is operable to control a media device 102, such as, but not limited to, a set top box (STB). The non-limiting exemplary media device 102 comprises a media content stream interface 302, a processor system 304, a memory 306, a buffer 308, an optional digital video recorder (DVR) 310, a presentation device interface 312, a remote interface 314, and an optional communication system interface 316. The memory 306 comprises portions for storing the media device logic 318, an optional browser 320, the additional supplemental information logic 322, and the additional supplemental information 324. In some embodiments, the media device logic 318, the browser 320, and/or the additional supplemental information logic 322 may be integrated with each other and/or may be integrated with other logic. In other embodiments, some or all of these memory and other data manipulation functions may be provided by and using remote server or other electronic devices suitably connected via the Internet or otherwise to a client. Other media devices may include some, or may omit some, of the above-described media processing components. Further, additional components not described herein may be included in alternative embodiments.

The functionality of the media device 102, here a set top box, is now broadly described. A media content provider provides media content that is received in one or more multiple media content streams 104 that may be optionally multiplexed together in one or more transport channels. The transport channels with the media content streams 104 are communicated to the media device 102 from a media system sourced from a remote head end facility (not shown) operated by the media content provider. Non-limiting examples of such media systems include satellite systems, cable system, and the Internet. For example, if the media content provider provides programming via a satellite-based communication system, the media device 102 is configured to receive one or more broadcasted satellite signals detected by an antenna (not shown). Alternatively, or additionally, the media content stream 104 can be received from one or more different sources, such as, but not limited to, a cable system, a radio frequency (RF) communication system, or the Internet.

The one or more media content streams 104 are received by the media content stream interface 302. One or more tuners 326 in the media content stream interface 302 selectively tune to one of the media content streams 104 in accordance with instructions received from the processor system 304. The processor system 304, executing the media device logic 318 and based upon a request for a media content of interest specified by a user, parses out media content associated with the media content event of interest. The program of interest, here a newscast program, is then assembled into a stream of video and/or audio information which may be stored by the buffer 308 such that the media content can be streamed out to the media presentation device 106, such as the television, via the presentation device interface 312. Alternatively, or additionally, the parsed out media content may be saved into the DVR 310 for later presentation. The DVR 310 may be directly provided in, locally connected to, or remotely connected to, the media device 102.

The exemplary media device 102 is configured to receive commands from a user via a remote control 118. The remote control 118 includes one or more controllers 120. The user, by actuating one or more of the controllers 120, causes the remote control 118 to generate and transmit commands, via a wireless signal 328 received by the remote interface 314, to the media device 102. The commands control the media device 102 and/or control the media presentation device 106. The wireless signal 328 may be an infrared signal or an RF signal.

The above processes performed by the media device 102 are generally implemented by the processor system 304 while executing the media device logic 318. Thus, the media device 102 may perform a variety of functions. The processor system 304 retrieves and executes the additional supplemental information logic 322 so that, in response to a user request, the additional supplemental information is presented by the media presentation device 106.

In some embodiments, one of the controllers 120 is predefined as having the function of initiating presentation of the additional supplemental information, assuming that the additional supplemental information is available. Accordingly, upon actuation of that particular controller 120 at times when the additional supplemental information is available, the additional supplemental information image 202, and any available audio information, is presented to the user.

In some situations, additional supplemental information associated with a presented supplemental information window 116 may not always be available for every one of the presented supplemental information windows 116. Accordingly, some embodiments prompt the user by presenting an optional graphical icon 330 to indicate the availability of the additional supplemental information. In some embodiments, all of, or a portion of, the supplemental information window 116 may become highlighted to indicate the availability of the additional supplemental information.

Some embodiments may require the user to actuate one of the controllers 120 to cause the supplemental information window 116 to become focused. A subsequent actuation of the controller 120, or a different controller 120, initiates presentation of the supplemental information window 116.

Some embodiments may present an optional confirmation element 332, such as a confirmation window, a confirmation graphic, or the like, to the user to confirm that the user wants to initiate presentation of the additional supplemental information. Upon receiving the user's confirmation, via actuation of one or more of the controllers 120, presentation of the additional supplemental information image 202 is initiated. That is, the presented additional supplemental information is presented in response to receiving the confirmation.

In some embodiments, the additional supplemental information is communicated separately to the media device in a media content stream 104. Accordingly, the tuner 326 tunes to the media content stream 104 having the additional supplemental information. The additional supplemental information image 202 may then be generated based on the received additional supplemental information. Upon conclusion of the presentation of the additional supplemental information, the tuner 326 retunes back to the original news broadcast event.

Alternatively, a second tuner (not shown), a virtual tuner, or the like, concurrently tunes to the media content stream 104 having the additional supplemental information. The additional supplemental information image 202 may then be generated based on the received additional supplemental information. Upon conclusion of the presentation of the additional supplemental information, the media content concurrently received by the tuner 326 (the original news broadcast event) may be immediately resumed.

In some embodiments, the additional supplemental information is interleaved with the media content of the news broadcast event. The interleaved additional supplemental information may be communicated to the media device 102 in advance or the presentation of the corresponding supplemental information window 116. The interleaved additional supplemental information is accessed by the processor system 304, and is stored into the buffer 308, the DVR 310, or another suitable memory medium. In the event that the user requests the additional supplemental information, the stored additional supplemental information may be immediately retrieved and presented.

The remote interface 314 is an exemplary type of user interface that is configured to receive the wireless signal 328. Any suitable user interface may be used by the various embodiments. For example, but not limited to, a user interface may be configured to receive input from a keyboard, a mouse, a game controller, or the like. Some embodiments may include a touch sensitive display 108, which is itself a user interface that is configured to receive the request to present the additional supplemental information.

Some embodiments may be configured to establish the communication link 128 to the external device 124, via the Internet. Accordingly, a suitable Internet identifier, such as a web page address or the like, is included in the media content of the news broadcast event and/or the content that generates the supplemental information window 116. the Internet identifier includes information necessary to establish the communication link 128 and to request the additional supplemental information from the external device 124.

It should be emphasized that the above-described embodiments of the news segment enhancement system 100 are merely possible examples of implementations of the invention. Many variations and modifications may be made to the above-described embodiments. All such modifications and variations are intended to be included herein within the scope of this disclosure and protected by the following claims.

1. A method for accessing additional supplemental information associated with a news broadcast event, the method comprising:
serially presenting a plurality of news segments of the news broadcast event on a display;
presenting at least one supplemental information window concurrently with the presented plurality of news segments on the display;
receiving a request to present additional supplemental information that is associated with the at least one supplemental information window;
accessing the additional supplemental information; and
presenting the additional supplemental information on the display.

2. The method of claim 1, further comprising:
pausing presentation of a currently presented news segment,
wherein the presented additional supplemental information replaces the currently presented news segment.

3. The method of claim 1, further comprising:
continuing presentation of a currently presented news segment,
wherein the presented additional supplemental information is concurrently presented with the currently presented news segment.

4. The method of claim 3, further comprising:
muting an audio portion presentation of the currently presented news segment; and
presenting an audio portion of the additional supplemental information.

5. The method of claim 3, wherein presenting the additional supplemental information on the display comprises:
presenting a video portion of the concurrently presented additional supplemental information in a picture-in-picture format over the currently presented news segment.

7. The method of claim 1, wherein the additional supplemental information is interleaved with media content in a received media content stream prior to presentation of the associated supplemental information window, and further comprising:
accessing the interleaved additional supplemental information from the media content stream;
storing the accessed additional supplemental information; and
presenting the stored additional supplemental information in response to receiving the request.

8. The method of claim 1, wherein the additional supplemental information is accessible from an external device, and further comprising:
establishing a communication link to the external device in response to receiving the request to present additional supplemental information; and
receiving the additional supplemental information from the external device via the established communication link.

9. The method of claim 1, wherein prior to presenting the additional supplemental information, the method further comprising:
presenting a confirmation element confirming the request to present additional supplemental information; and
receiving a confirmation confirming the request,
wherein the presented additional supplemental information is presented in response to receiving the confirmation.

10. The method of claim 1, wherein receiving the request to present the additional supplemental information further comprises:
receiving a wireless signal from a remote control, wherein the wireless signal is generated in response to actuation of at least one controller on the remote control that is associated with generating the request,
wherein the additional supplemental information is presented in response to receiving the wireless signal from the remote control.

11. The method of claim 1, wherein a media device is configured to receive a media content stream with the news broadcast event, and wherein presenting the additional supplemental information further comprises:
communicating the additional supplemental information from the media device to a media presentation device with the display,
wherein the presented additional supplemental information is presented on the display.

12. The method of claim 1, wherein presenting at least one supplemental information window further comprises:
presenting a graphical icon on the display to indicate availability of the additional supplemental information.

13. A media device, comprising:
a media content stream interface configured to receive a media content stream having a news broadcast event;
a user interface configured to receive a request to view additional supplemental information that is associated with the at least one supplemental information window; and
a processor system communicatively coupled to the media content stream interface and the user interface, wherein the processor system is configured to:
communicate information to serially present a plurality of news segments of the news broadcast event on a display; communicate information to present at least one supplemental information window on the display, wherein the at least one supplemental information window is displayed concurrently with the plurality of news segments by the display;
access the additional supplemental information; and
communicate information to present the additional supplemental information on the display in response to the received request.

14. The media device of claim 13, further comprising:
the display.

15. The media device of claim 13, further comprising:
a presentation device interface configured to communicatively couple the media device to a media presentation device, wherein the information communicated to present the serially presented plurality of news segments, the information to present at least one supplemental information window, and the information to present the additional supplemental information is communicated via the presentation device interface to the media presentation device.

16. The media device of claim 13, further comprising:
a communication system interface configured to communicatively couple the media device to an external device, wherein the additional supplemental information is communicated from the external device to the media presentation device via the communication system interface.

17. The media device of claim 13, wherein the additional supplemental information is received by the media device prior to presentation of the at least one supplemental information window, and further comprising:
at least one of a buffer and a digital video recorder (DVR) configured to save the prior received additional supplemental information, wherein the saved additional supplemental information is retrieved from the at least one of the buffer and the DVR for presentation in response to receiving the request.

18. The media device of claim 13, further comprising:
a first tuner configured to receive a first media content stream comprising the serially presented plurality of news segments; and
a second tuner configured to receive a second media content stream comprising the additional supplemental information, wherein the supplemental information is retrieved from the second tuner for presentation in response to receiving the request.

19. A method for accessing additional supplemental information associated with a news broadcast event, the method comprising:
receiving a media content stream, the media content stream comprising a plurality of news segments of a news broadcast event, supplemental information, and additional supplemental information;
retrieving from the media content stream the plurality of news segments of the news broadcast event to present on a display;
retrieving from the media content stream the supplemental information to present on the display in the supplemental information window, wherein the supplemental information window is concurrently presented with the plurality of news segments on the display;
receiving a request to present additional supplemental information that is associated with the supplemental information; and
retrieving from the media content stream the additional supplemental information to present on the display in response to receiving the request.

20. The method of claim 19, wherein the additional supplemental information is received in the media content stream prior to receiving the supplemental information window in the media content stream, and further comprising:
saving the prior received additional supplemental information in at least one of a buffer and digital video recorder (DVR); and
retrieving the saved additional supplemental information from the at least one of the buffer and the DVR in response to receiving the request.
